(19) United States
(12) Patent Application Publication
(10) Pub. No.: US 2024/0142698 A1
(43) Pub. Date: May 2, 2024

(54) MANAGING OPTICAL AMPLIFICATION IN OPTICAL PHASED ARRAY SYSTEMS

(71) Applicant: Analog Photonics LLC, Boston, MA (US)

(72) Inventors: Michael Robert Watts, Hingham, MA (US); Matthew Byrd, Arlington, MA (US); Christopher Vincent Poulton, Somerville, MA (US)

(73) Assignee: Analog Photonics LLC, Boston, MA (US)

(21) Appl. No.: 18/495,428

(22) Filed: Oct. 26, 2023

Related U.S. Application Data
(60) Provisional application No. 63/420,054, filed on Oct. 27, 2022.

(51) Int. Cl. G02B 6/12; G02F 1/00

(52) U.S. Cl. CPC G02B 6/12019; G02B 6/12011; G02F 1/0063

(57) ABSTRACT

An optical coupler in a photonic chip is configured to couple an optical port to an array of optical phase shifters in the chip. An optical amplifier module is optically coupled to a portion of the chip to receive phase shifted optical waves, and is configured to: provide, after propagation of the phase shifted optical waves through different respective gain regions, amplified optical waves that optically interfere with each other starting at an emission plane to form an optical phased array output beam, and provide an arrangement of the gain regions such that (1) at least two phase shifted optical waves propagating through adjacent gain regions have optical path lengths between the optical port and the emission plane that are substantially equal to each other, and (2) a pitch of the gain regions is substantially equal to a pitch of the amplified optical waves at the emission plane.

### CROSS-REFERENCE TO RELATED APPLICATION(S)

This application claims the benefit of and priority to U.S. Provisional Application Ser. No. 63/420,054, entitled “MANAGING OPTICAL AMPLIFICATION IN INTEGRATED LIDAR SYSTEMS,” filed Oct. 27, 2022, which is incorporated herein by reference.

### TECHNICAL FIELD

This disclosure relates to managing optical amplification in optical phased array systems.

### BACKGROUND

Some LiDAR systems optimize various aspects of the LiDAR configuration based on different criteria. An optical wave is transmitted from an optical source to target object(s) at a given distance and the light backscattered from the target object(s) is collected. Some optical phased arrays (OPAs) used in such systems have a linear distribution of emitter elements (also called emitters or antennas). Steering about a first axis perpendicular to the linear distribution can be provided by changing the relative phase shifts in phase shifters feeding each of the emitter elements. Other techniques can be used for steering about a second axis orthogonal to the first axis. The optical source used in such a system is typically a laser, which provides an optical wave that has as narrow linewidth and has a peak wavelength that falls in a particular range (e.g., between about 100 nm to about 1 mm, or some subrange thereof), also referred to herein as simply “light”. The amount of optical power collected from backscattering off the target objects may be directly proportional to the amount of laser power that is transmitted.

### SUMMARY

In one aspect, in general, an apparatus comprises: a photonic chip; a first array of optical phase shifters in the photonic chip; a first optical coupler in the photonic chip configured to couple a first optical port to the first array of optical phase shifters; and an optical amplifier module optically coupled to a first portion of the photonic chip to receive phase shifted optical waves provided from respective optical waveguides in the photonic chip, where the phase shifted optical waves are optically coupled to respective output ports of the first array of optical phase shifters. The optical amplifier module is configured to: provide, after propagation of the phase shifted optical waves through different respective gain regions, amplified optical waves that optically interfere with each other starting at an emission plane to form an optical phased array output beam, and provide an arrangement of the gain regions such that (1) at least two phase shifted optical waves propagating through adjacent gain regions have optical path lengths between the first optical port and the emission plane that are substantially equal to each other, and (2) a pitch of the gain regions is substantially equal to a pitch of the amplified optical waves at the emission plane.

Aspects can include one or more of the following features.

The apparatus further comprises: a second array of optical phase shifters in the photonic chip; a second optical coupler in the photonic chip configured to couple a second optical port to the second array of optical phase shifters; and a receive aperture configured to optically couple a received optical beam, received at the emission plane, to the second array of optical phase shifters.

The receive aperture is adjacent to a transmit aperture from which the optical phased array output beam is transmitted.

The pitch of the gain regions is substantially equal to a pitch of the optical phase shifters.

The emission plane intersects with an edge of the optical amplifier module.

The optical amplifier module is optically coupled to a second portion of the photonic chip to provide the amplified optical waves to optical antennas in the photonic chip, and the emission plane intersects with an edge or surface of the photonic chip adjacent to the optical antennas.

The pitch of the gain regions is substantially equal to a pitch of the optical antennas.

The respective optical waveguides in the first portion of the photonic chip are a first set of optical waveguides, and the second portion of the photonic chip comprises a second set of optical waveguides configured to receive the amplified optical waves from the optical amplifier module.

The optical amplifier module comprises a substrate different from a material from which the first and second sets of optical waveguides are formed, and the optical amplifier module is positioned at least partially within a trench formed in the photonic chip, where at least one trench surface is adjacent to the first set of optical waveguides and at least one trench surface is adjacent to the second set of optical waveguides.

The respective optical waveguides all have optical path lengths that are substantially equal to each other.

The optical amplifier module is configured to provide the arrangement of the gain regions such that all of the phase shifted optical waves propagating through different respective gain regions have optical path lengths between the first optical port and the emission plane that are substantially equal to each other.

The optical amplifier module is configured to substantially preserve isolation among the phase shifted optical waves as they propagate through the optical amplifier module.

The respective optical waveguides each define a guided optical mode in a portion of the photonic chip that has a transmittance of at least 80% over an operating wavelength range.

The optical amplifier module comprises: a substrate that has an optical transmittance of at least 80% over the operating wavelength range, and the respective gain regions in the substrate, where each gain region is positioned to overlap with at least a portion of a respective optical mode in the substrate coupled to a different one of the guided optical modes defined by the respective optical waveguides.

A first gain region and a second gain region of the plurality of gain regions are isolated from each other by a gap in the substrate.

The first gain region and the second gain region are isolated from each other by an optically absorptive and/or reflective material within at least a portion of the gap in the substrate.

The optically absorptive and/or reflective material comprises metal.

The optically absorptive and/or reflective material is configured as a first electrode that provides current flow between a second electrode and the first electrode during operation, where the current flow crosses at least a portion of the first gain region.

In another aspect, in general, a method comprises: forming a first array of optical phase shifters in a photonic chip; forming a first optical coupler in the photonic chip configured to couple a first optical port to the first array of optical phase shifters; and attaching an optical amplifier module to a first portion of the photonic chip to provide optical coupling that receives into the optical amplifier module phase shifted optical waves provided from respective optical waveguides in the photonic chip, where the phase shifted optical waves are optically coupled to respective output ports of the first array of optical phase shifters. The optical amplifier module is configured to: provide, after propagation of the phase shifted optical waves through different respective gain regions, amplified optical waves that optically interfere with each other starting at an emission plane to form an optical phased array output beam, and provide an arrangement of the gain regions such that (1) at least two phase shifted optical waves propagating through adjacent gain regions have optical path lengths between the first optical port and the emission plane that are substantially equal to each other, and (2) a pitch of the gain regions is substantially equal to a pitch of the amplified optical waves at the emission plane.

In another aspect, in general, an apparatus comprises: a photonic chip; a first array of optical phase shifters in the photonic chip; a first optical coupler in the photonic chip configured to couple a first optical port to the first array of optical phase shifters; and an optical amplifier module optically coupled to a first portion of the photonic chip to overlap with portions of phase shifted optical waves guided by respective optical waveguides in the photonic chip, where the phase shifted optical waves are optically coupled to respective output ports of the first array of optical phase shifters. The optical amplifier module is configured to: provide a gain region that is within a substrate that is adjacent to the respective optical waveguides, and provide, after propagation of the overlapping portions of the phase shifted optical waves through different respective portions of the gain region, amplified optical waves that optically interfere with each other starting at an emission plane to form an optical phased array output beam.

Aspects can include one or more of the following features.

The apparatus further comprises: a second array of optical phase shifters in the photonic chip; a second optical coupler in the photonic chip configured to couple a second optical port to the second array of optical phase shifters; and a receive aperture configured to optically couple a received optical beam, received at the emission plane, to the second array of optical phase shifters.

The emission plane intersects with an edge of the optical amplifier module.

The respective optical waveguides provide the amplified optical waves to optical antennas in the photonic chip, and the emission plane intersects with an edge or surface of the photonic chip adjacent to the optical antennas.

The optical amplifier module comprises substrate different from a material from which the respective optical waveguides are formed, and the optical amplifier module is positioned at least partially within a trench formed in the photonic chip, where at least one trench surface is adjacent to the respective optical waveguides.

In another aspect, in general, a method comprises: forming a first array of optical phase shifters in a photonic chip; forming a first optical coupler in the photonic chip configured to couple a first optical port to the first array of optical phase shifters; and attaching an optical amplifier module to a first portion of the photonic chip to provide optical coupling that overlaps the optical amplifier module with portions of phase shifted optical waves guided by respective optical waveguides in the photonic chip, where the phase shifted optical waves are optically coupled to respective output ports of the first array of optical phase shifters. The optical amplifier module is configured to: provide a gain region that is within a substrate that is adjacent to the respective optical waveguides, and provide, after propagation of the overlapping portions of the phase shifted optical waves through different respective portions of the gain region, amplified optical waves that optically interfere with each other starting at an emission plane to form an optical phased array output beam.

Aspects can have one or more of the following advantages.

In some examples disclosed herein, an optical amplifier module can be located after the optical phase shifters and before the antenna array of an OPA, thereby increasing the output optical power and efficiency of the OPA. The increased optical power output enabled by the techniques disclosed herein may allow for increased sensitivity in OPA systems such as LiDAR systems or free space optical communication systems.

In some examples, the optical amplifier module disclosed herein may be designed to be similar in width to an array of optical phase shifters on a transmitter OPA, thus allowing the transmitter OPA to be utilized in a full LiDAR system with one or more receive apertures in close proximity. For example, the width of an optical amplifier module can be similar to the width of an array of optical phase shifters and a corresponding array of optical antennas by making the pitch of waveguides or other transmission paths of optical waves through the optical amplifier module substantially equal to the pitch of the optical phase shifters and/or the pitch of the optical antennas. Also disclosed are waveguide geometries and material properties, as well as metallic structures, that may be used to reduce waveguide-to-waveguide coupling in an optical amplifier module (e.g., characterized by a small pitch between amplifier waveguides). Some examples of optical amplifier modules disclosed herein may be simpler to fabricate and align with photonic chips (e.g., by enabling evanescent coupling).

In some examples, the optically amplified photonic chip assembly may be configured to transmit optical modes over two or more paths from an optical input port to an emission plane that have substantially equal optical path lengths. One advantage to such a configuration is that it allows for the relative phase shifts of the two or more paths to be substantially preserved across a range of wavelengths. By substantially preserving the relative phase shifts, simpler or no calibration of optical phase shifters in the optically amplified photonic chip assembly may be possible. Such optical path length matched configurations can be more easily achieved without requiring complicated routing of waveguides on chip such as, for example, by straight optical transmission paths through the optical amplifier module that has similar pitch to the pitch of the optical phase shifters and/or the pitch of the optical antennas, as described herein.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic diagram of an example optically amplified photonic chip assembly.

FIG. 2 is a schematic diagram of an example of a LiDAR system.

FIG. 3 is a schematic diagram of an example of an optical phased array.

FIG. 4 is a schematic diagram of an example of a grating-antenna-based optical phased array.

FIG. 5 is a schematic diagram of an example of angular steering associated with radiation intensity patterns for optical phased arrays.

FIG. 6 is a schematic diagram of an example OPA system.

FIGS. 7A, 7B, and 7C are schematic diagrams of a portion of an example optically amplified photonic chip assembly.

FIGS. 8A and 8B are schematic diagrams of a portion of an example optically amplified photonic chip assembly.

FIG. 9A is a schematic diagram of an example ridge-like waveguide.

FIG. 9B is a schematic diagram of an example strip-like waveguide.

FIG. 9C is a schematic diagram of an example low index contrast waveguide.

FIG. 9D is a schematic diagram of an example high index contrast waveguide.

FIG. 9E is a schematic diagram of an example metallically isolated waveguide.

FIGS. 10A and 10B are schematic diagrams of a portion of an example optically amplified photonic chip assembly.

FIGS. 11A and 11B are schematic diagrams of a portion of an example optically amplified photonic chip assembly.

FIGS. 12A and 12B are schematic diagrams of a portion of an example optically amplified photonic chip assembly.

### DETAILED DESCRIPTION

In some applications of optical phased arrays (OPAs), such as in LiDAR, it may be advantageous to transmit higher optical powers to scatter from a target object in order to receive back a larger optical signal with a possibly lower signal-to-noise ratio. However, some of the optical components inside OPAs (e.g., splitter trees, waveguides, and optical phase shifters) can have optical losses, and light with higher optical power that traverses such optical components can correspondingly have larger amounts of optical power lost. Thus, if light traversing through an OPA (e.g., provided from a seed laser) has been optically amplified prior to such optical components, the OPA may have excess optical loss compared to if such optical amplification had occurred after such optical components. In general, excess loss may result in a significant degradation of the wall-plug efficiency of the overall OPA. Furthermore, a single channel optical amplifier (e.g., located prior to a splitting tree in a transmitting OPA) may have a practical limit on the amount of optical power that it can optically couple into the transmitting OPA (e.g., the maximum output optical power of the optical amplifier may be limited, or the optical power handling capability of any of the optical components prior to the OPA, such as optical fibers, spot-size converters, or waveguides, may be limited).

In some examples disclosed herein, an optical amplifier module can be located after the optical phase shifters and before the antenna array of an OPA, thereby increasing the output optical power and efficiency of the OPA. Such an optical amplifier may be referred to as an inline optical amplifier. In such examples, light from a low-power (e.g., non-amplified) seed laser can be used as input for the OPA, and despite undergoing optical loss across a splitter tree and an array of optical phase shifters, for example, the total optical loss can be reduced and the total system wall-plug efficiency increased. In some examples, the optical amplifier module can consume the largest electrical energy of the OPA, making efficiency of the light generated by the optical amplifier module a substantial factor in the efficiency of the device.

In general, the amount of optical power received may be directly proportional to the receiver area, such that large apertures may be desired for long range LiDAR systems. In order to achieve a large aperture system in a scalable manner, the optical amplifier module may be designed to be similar in width to the array of optical phase shifters. Such a design may allow the OPA transmitter to be utilized in a full LiDAR system with one or more receive apertures in close proximity.

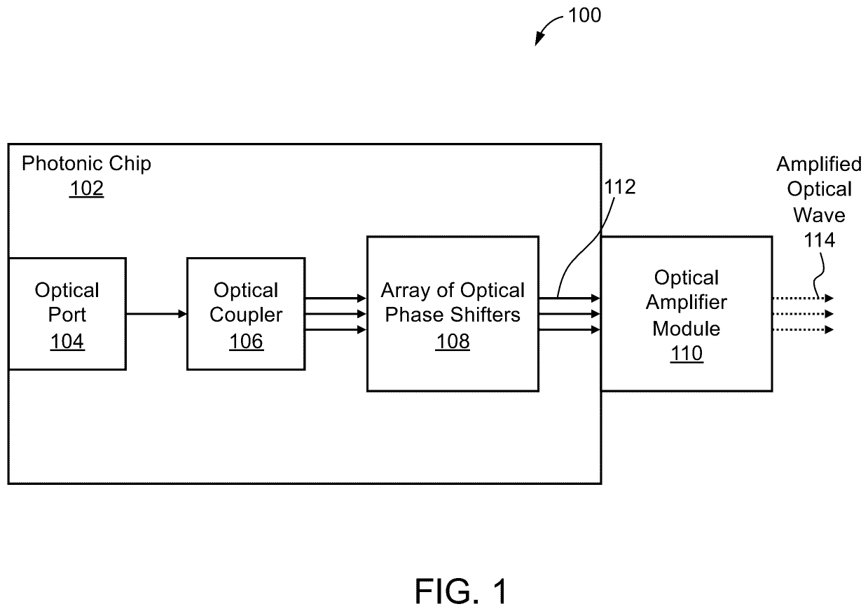

FIG. 1 shows an example optically amplified photonic chip assembly 100. Within a photonic chip 102 there is a first optical coupler 106 (e.g., a splitter tree) configured to couple a first optical port 104 to a first array of optical phase shifters 108. An optical amplifier module 110 is optically coupled to a first portion of the photonic chip 102 to receive phase shifted optical waves provided from respective optical waveguides 112 in the photonic chip 102, where the phase shifted optical waves are optically coupled to respective output ports of the first array of optical phase shifters 108. For example, the optical amplifier module 110 can be positioned within a portion of the photonic chip 102 such as a trench (not shown), as described in more detail in some of the examples below. In this way, the optical amplifier module 110 can use a substrate material (e.g., a III-V semiconductor material such as indium phosphide) that is different from a substrate material of the photonic chip (e.g., silicon) and may be more suitable for providing optical amplification (i.e., optical gain). The optical amplifier module 110 is configured to provide, after propagation of the phase shifted optical waves through different respective gain regions (not shown), amplified optical waves 114 that optically interfere with each other starting at an emission plane (not shown) to form an optical phased array output beam (not shown). The optical amplifier module 110 is further configured to provide an arrangement of the gain regions such that (1) at least two phase shifted optical waves propagating through adjacent gain regions have optical path lengths between the first optical port 104 and the emission plane that are substantially equal to each other, and (2) a pitch of the gain regions is substantially equal to a pitch of the amplified optical waves 114 at the emission plane. As used herein, optical path length refers to the physical length of a transmission path through a material (or through air) multiplied by the index of refraction of the material (or an index of refraction of about 1 for air). In some materials the index of refraction is wavelength dependent.

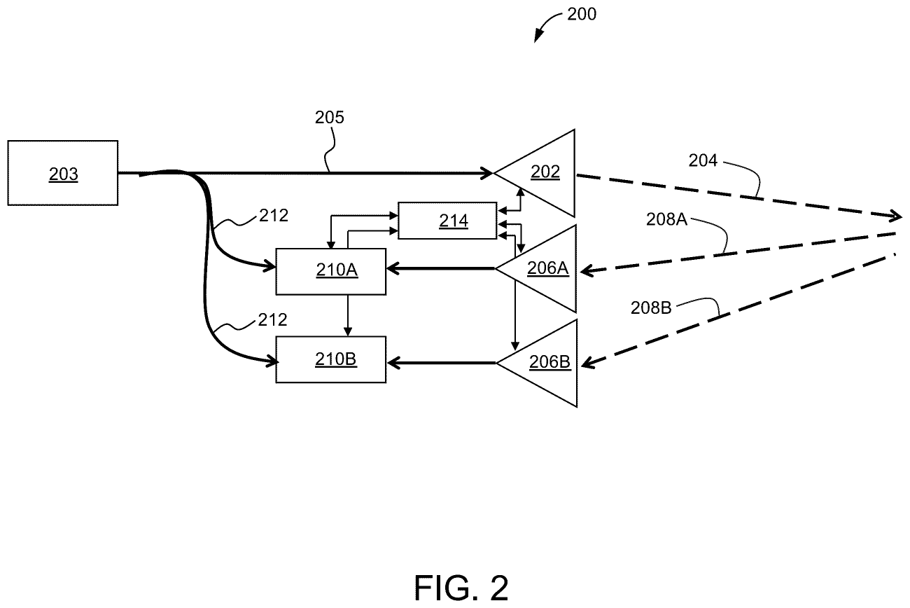

FIG. 2 shows an example of a LiDAR system 200 in which a transmitter OPA coupled to an optical amplifier module as shown in FIG. 1 can be used. The system 200 uses a configuration that can include one or more transmitter (Tx) antenna modules and one or more receiver (Rx) antenna modules. For example, some implementations are configured to use separate Tx and Rx antenna modules, where the separate antenna modules provide a separate transmitting aperture and receiving aperture (i.e., in a bistatic arrangement). In other implementations, there is an antenna module configured to operate in both a transmitter (Tx) mode of operation and a receiver (Tx) mode of operation (i.e., in a monostatic arrangement) where the transmitting aperture and the receiving aperture are the same. In the example of FIG. 2, the system 200 includes a transmitter antenna module 202 that transmits an optical beam 204 at an angle that can be steered over a steering range, and two receiver antenna modules 206A and 206B that can each be controlled to receive light incoming from a particular angle (i.e., a multi-static arrangement). For example, the receiver antenna module 206A can be configured to receiving incoming light 208A including a portion of the optical beam 204 backscattered from a target object or region, and the receiver antenna module 206B can be configured to receive incoming light 208B including a portion of the optical beam 204 backscattered from the target.

The system includes an optical source 203 that provides an optical wave 205 to the transmitter antenna module 202. In some implementations, the optical source 203 is a continuous wave (CW) coherent light source (e.g., a laser) that provides an optical wave that has a narrow linewidth and low phase noise, for example, sufficient to provide a temporal coherence length that is long enough to perform coherent detection over the time scales of interest. In some implementations, the optical source 203 is a frequency tunable laser system in which the frequency of the light provided can be swept to perform frequency modulated continuous wave (FMCW) LiDAR measurements. Coherent receiver modules 210A and 210B receiving collected light from receiver antenna modules 206A and 206B, respectively, are configured to coherently mix the collected light with light of a local oscillator (LO) 212, which can be derived from the optical source 203 or from a portion of the optical wave 205 provided to the transmitter antenna module 202. A photodetection system, such as a balanced detector or an in-phase/quadrature-phase (IQ) detector, can be used to obtain one or more electrical signals representing the strength of a beat signal that has a maximum amplitude when the frequency of the LO and the received light are substantially equal.

A control module 214 is configured to control various aspects of the antenna modules and coherent receiver modules to determine information about a target object associated with a detection event based at least in part on one or more characteristics of the received backscattered light. In addition to a location of a target object that has backscattered light, there may also be range information characterizing a distance to the target object, and/or velocity information characterizing a relative speed of the target object, that can be obtained based at least in part on a frequency chirp (e.g., a linear chirp) that is applied to the optical wave 205 generated by the optical source 203. The control module 214 can include electronic circuitry (e.g., application specific integrated circuit, and/or processor cores), and in some cases is integrated on the same photonic integrated circuit including the antenna modules or on an electronic integrated circuit mounted to the photonic integrated circuit including the antenna modules.

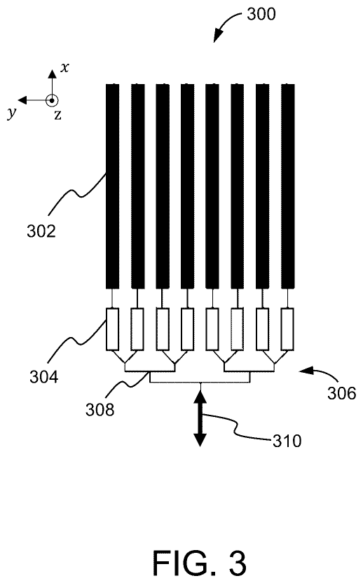

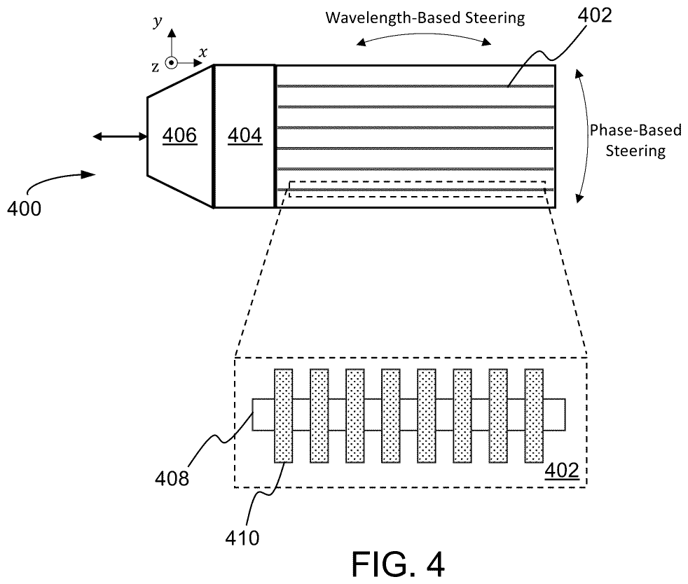

Any of a variety of techniques can be used to steer the transmission angle of the optical beam 204 provided by the transmitter antenna module 202 over a steering range, and to steer the reception angle of the receiver antenna modules 206A and 206B. In some implementations, an OPA is used to enable steering of a lobe of a radiation intensity pattern (also referred to as a gain pattern) associated with the OPA. Some OPAs have a linear distribution of optical antennas. Steering about a first axis perpendicular to the linear distribution can be provided, for example, by changing the relative phase shifts in phase shifters coupled to each of the optical antennas. For example, FIG. 3 shows an example OPA 300 that includes an array of optical antennas 302. Light can be emitted from (and/or received into) optical antennas 302 from different emission planes depending on the type of optical antennas being used. For a grating-antenna-based OPA, each optical antenna is configured as an optical grating, as described in more detail in FIG. 4, and power from individual optical waves is emitted gradually over the length of the optical gratings over an emission plane in the plane of the page in FIG. 3 (the x-y plane). Alternatively, for an end-fire-antenna-based OPA, each optical antenna is configured to emit light from the ends of the optical antennas at an emission plane that is perpendicular to the plane of the page in FIG. 3 (the y-z plane). In either case, the optical waves optically interfere with each other starting at the emission plane to form an optical phased array output beam when the OPA 300 is used as a transmitter. The direction of peak constructive interference depends on the relative phase shifts imposed on light entering the optical antennas.

The OPA 300 includes an array of optical phase shifters 304 that impose respective phase shifts on optical waves provided as phase shifted optical waves entering the respective optical antennas 302 when the OPA is used as a transmitter, or on optical waves that have been collected by respective optical antennas 302 when the OPA is used as a receiver. The optical phase shifters 304 can be, for example, electro-optic, thermal, liquid crystal, pn junction phase shifters. In some examples, each of the optical phase shifters 304 is controlled independently, while in other examples two or more of the optical phase shifters 304 may be jointly controlled. An optical coupler 306 is configured to couple an optical port 310 to the array of optical phase shifters 304. In this example, the optical coupler 306 is in the form of a power splitting network formed form interconnected power splitters 308. In this example, the power splitters 308 are 1×2 power splitters (also referred to as 50/50 power splitters) and are interconnected by waveguides in a binary tree arrangement to achieve substantially equal power into each optical phase shifter 304 from an input optical wave entering the optical port 310 when the OPA 300 is used as a transmitter (Tx operation), and to provide substantially equal path lengths between each optical phase shifter 304 and the optical port 310. When the OPA 300 is used as a receiver (Rx operation), the light received by the optical antennas 302 and phase shifted by the optical phase shifters 304 is combined into an output optical wave at the optical port 108, which can then be further manipulated, transformed, or measured.

FIG. 4 shows an example of a grating-antenna-based OPA 400 that is configured for phase-based steering about the x axis and wavelength-based steering about they axis. For example, when configured for Tx operation, optical waves propagate along optical grating antennas 402 (along the x axis), and light is perturbed and gradually emitted from various locations over the x-y emission plane. With this two-dimensional (2D) steering configuration, steering can be performed along transverse (e.g., polar and azimuth) angular directions in a polar coordinate system, with the steering in one angular direction being performed by phase shifters in a phase shifter (PS) module 404 and the steering in the other angular direction being performed by wavelength of an optical wave distributing optical power via an optical coupler 406. The adjustment of the transmission angle for the Tx operation and collection angle for the Rx operation in the phase-controlled angular direction can be dynamically performed as the phases imposed by the phase shifters in the PS module 404 can be quickly tuned. Each optical grating antenna 402 is formed from a waveguide 408 and grating elements 410 arranged periodically along the waveguide 408 with a particular pitch p1 (e.g., a constant spacing between grating elements 410) to perturb the guided optical wave causing emission in the direction of the grating elements 410. The angle at which the light is emitted from each optical grating antenna 402 depends on a relationship between the pitch p1 and the wavelength, and thus can be steered by changing the wavelength.

The PS module 404 can also be configured to provide focusing. For example, the emitted light can have a nonlinear phase front imposed on it by the phase shifters in the PS module 404 for focusing in Tx operation. This dynamically adjusted phase front can also tune the focal depth for Rx operation. Other techniques can be used for steering about a second axis orthogonal to the phase-based steering axis (e.g., mechanical based steering), such as when wavelength-based steering is not used for an optical grating antenna, or when an end-fire optical antenna is used.

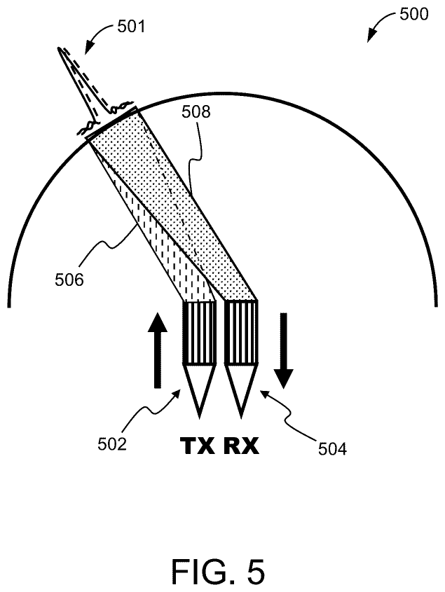

FIG. 5 shows an example LiDAR system 500 producing radiation intensity patterns 501 associated with a transmitter OPA 502 and a receiver OPA 504. In this example, main lobes associated with a transmitter radiation pattern 506 and a receiver radiation pattern 508 overlap. Such an arrangement of main lobe overlap can result, for example, from tuning phase shifters associated with transmitter and receiver optical antennas in the respective OPAs. Backscattered light from a target object situated near the main lobes is received by the receiver OPA 504. In each radiation intensity pattern, there may be a main lobe and additional grating lobes that occur on each side of the main lobe due to the limit in how close adjacent optical antennas can be in an OPA, which may limit the phase-based angular tuning range. In some implementations, the examples described herein may be designed to operate over a predetermined range of optical wavelengths such as, for example, the λ=1500 to 1600 nm band or the λ=1270 to 1330 nm band, and the pitch p2 corresponding to a distance between adjacent optical antennas may be of similar magnitude to the optical wavelength to increase the spacing between grating lobes (and thereby increase tuning range), or in some cases less than half of the optical wavelength to avoid grating lobes. For example, for operation in the 1500 to 1600 nm band, 700 nm≤p2≤4000 nm may be typical.

As described above, in some LiDAR systems, a transmitter OPA includes an optical amplifier module. In some implementations, the optical amplifier module is configured to substantially preserve isolation among different optical waves. The physical structure of the optical amplifier module can take different forms and need not contain optical waveguides.

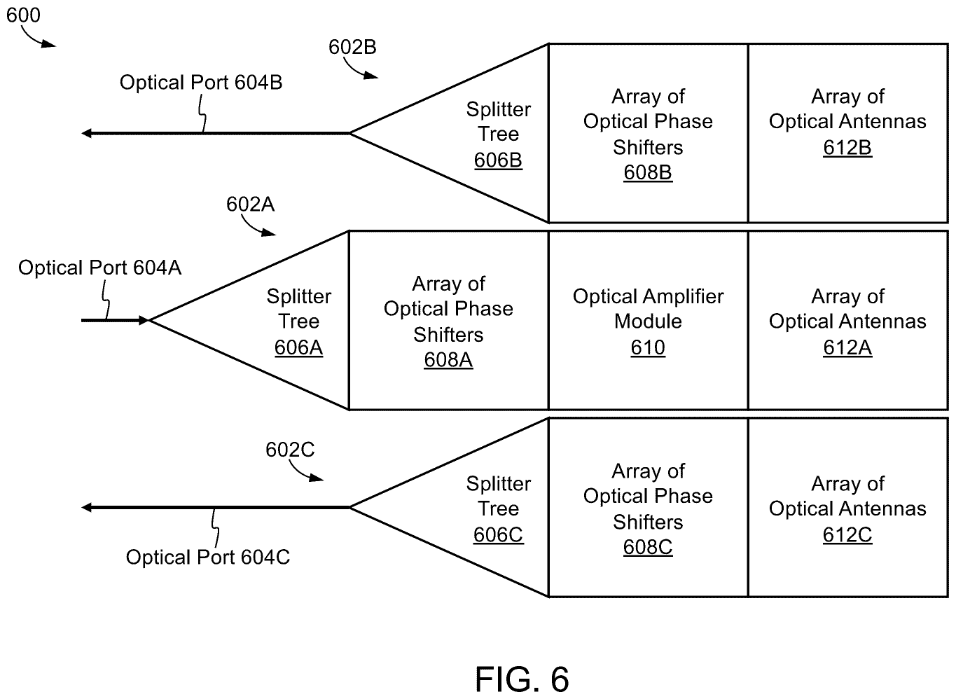

FIG. 6 shows an example OPA system 600 comprising a transmitter OPA 602A, a first receiver OPA 602B, and a second receiver OPA 602C. Light can be coupled into the transmitter OPA 602A at a first optical port 604A that is optically coupled to a first splitter tree 606A that splits the light into two or more paths. Each of the paths are then coupled to respective optical phase shifters in a first array of optical phase shifters 608A. The first array of optical phase shifters 608A is optically coupled to an optical amplifier module 610. In this example, the optical amplifier module 610 is optically coupled to an array of optical antennas 612A. In other examples, the array of optical antennas 612A may be absent and the optical amplifier module 610 may directly emit light from an end portion (e.g., an end facet) of the optical amplifier module 610. Light (e.g., emitted from the transmitter OPA 602A and backscattered from a target) can be received by a second array of optical antennas 612B and/or a third array of optical antennas 612C. The second array of optical antennas 612B is optically coupled to a second array of optical phase shifters 608B that is optically coupled to a second splitter tree 606B that is optically coupled to a second optical port 604B. The third array of optical antennas 612C is optically coupled to a third array of optical phase shifters 608C that is optically coupled to a second splitter tree 606C that is optically coupled to a third optical port 604C. The first splitter tree 606A, the second splitter tree 606B, and the third splitter tree 606C may each comprise waveguides in a binary tree arrangement. For example, a binary tree network of 1×2 splitters can be interconnected by waveguides or by directly connecting the outputs of one 1×2 splitter to the inputs of other 1×2 splitters. In general, the architecture of the OPA system 600 is scalable, such that the number of transmitting OPAs and receiving OPAs can be flexibly designed and can depend on the application.

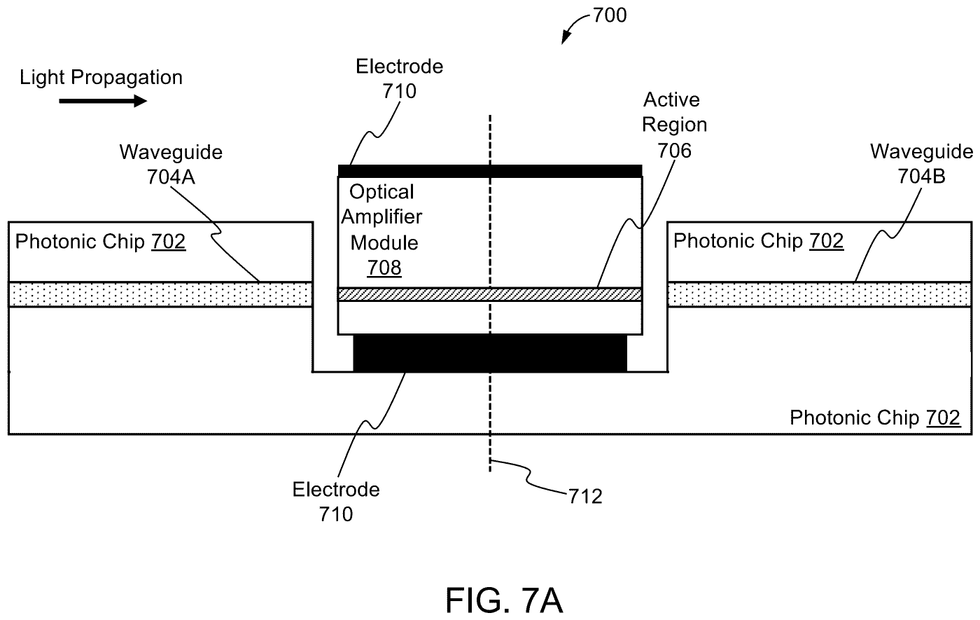

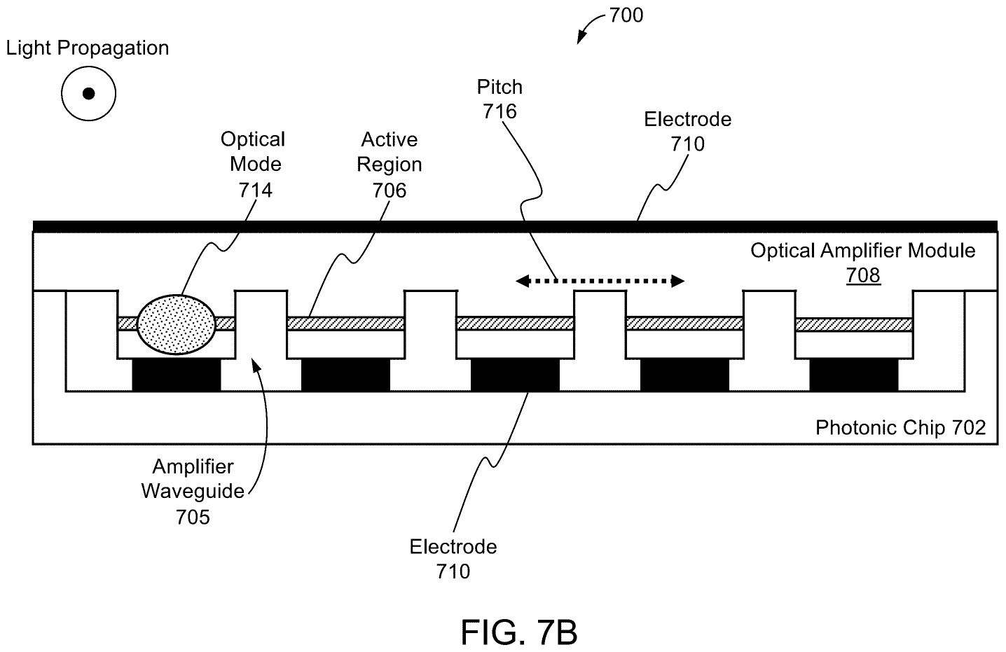

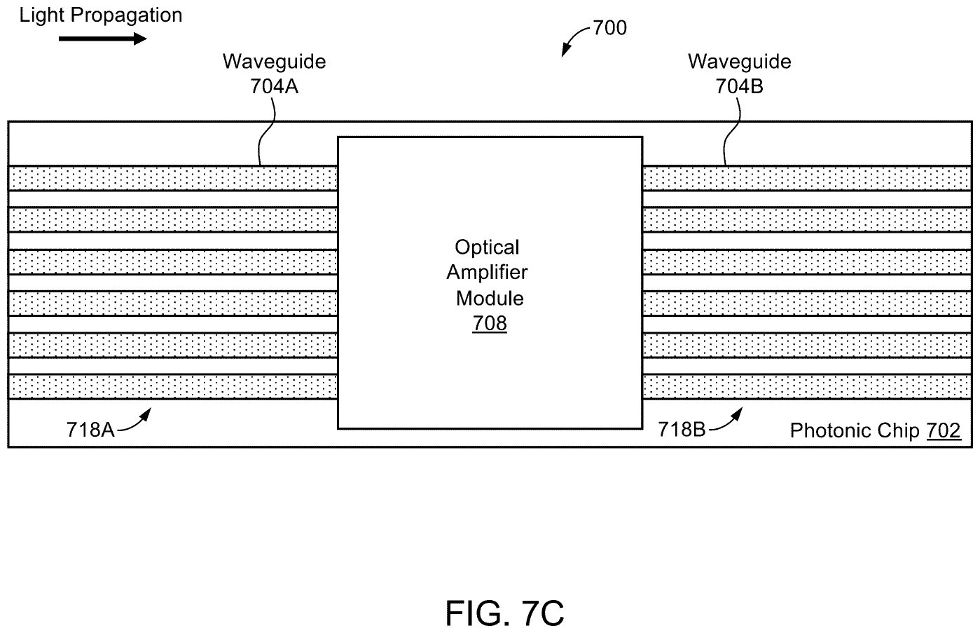

FIG. 7A shows a first cross-sectional view of a portion of an example optically amplified photonic chip assembly 700, where light propagation is along a propagation axis within the plane of the page as indicated. Light (e.g., optical waves transmitted from an array of optical phase shifters) propagates within a photonic chip 702 along a first waveguide 704A in a first array of waveguides (arrayed into the page, not shown) and is directly coupled (i.e., butt-coupled) to an amplifier waveguide (not shown) in an array of amplifier waveguides (arrayed into the page, not shown) containing active regions 706 (e.g., one or more doped regions of a semiconductor substrate such as indium phosphide) in an optical amplifier module 708. Electrodes 710 are located on top of and underneath the optical amplifier module 708 and provide electrical pumping of the active regions 706 that amplify the light that overlaps with the active regions 706 and is subsequently directly coupled to a second waveguide 704B in a second array of waveguides (arrayed into the page, not shown). Electrodes 710 located on top of the optical amplifier module 708 may operate at a different voltage than electrodes 710 underneath the optical amplifier module 708 in order to pump the active regions 706. For example, the resulting voltage difference applied between the electrodes enables a pump current to flow across the active regions 706 to enable the active regions 706 to serve as a gain region that provides optical gain. Alternatively, any of a variety of techniques (e.g., quantum wells) could be used to enable an active region or other optical gain mechanism to serve as gain region. The second waveguide 704B may be optically coupled to an array of optical antennas (not shown) that emit the light from the photonic chip 702. Spot-size converters (not shown) or tapered waveguides (not shown) may be used to enhance the direct coupling between the first waveguide 704A and the amplifier waveguide, as well as the direct coupling between the amplifier waveguide and the second waveguide 704B. The optically amplified photonic chip assembly 700 may be assembled by using flip-chip attachment methods, where the optical amplifier module 708, after patterning the amplifier waveguides, is soldered to a trench etched in the photonic chip 702. In such examples, the alignment of the first array of waveguides to the array of amplifier waveguides may be performed by using precision flip-chip attachment tools. A dashed line 712 denotes a cross-section (i.e., plane) formed into the page for FIG. 7B.

FIG. 7B shows a second cross-sectional view of a portion of an example optically amplified photonic chip assembly 700, as viewed through a plane denoted by the dashed line 712 of FIG. 7A, where light propagation is along a propagation axis perpendicular to (i.e., into) the plane of the page as indicated. An optical mode 714 propagates through an active region 706 and is confined by an amplifier waveguide 705. In general, optical modes can propagate through each of the active regions 706 along respective amplifier waveguides 705. The active regions 706 and the amplifier waveguides 705 are arranged in an array with a pitch 716 (i.e., a distance between the centers of adjacent waveguides in the array). In some examples, optical phase shifters (not shown) and optical antennas (not shown) may have also be arranged in an array with the pitch 716 such that no fan-in and fan-out waveguides are used, thereby reducing the total device footprint.

FIG. 7C shows a portion of an example optically amplified photonic chip assembly 700, as viewed from above, where light propagation is along a propagation axis within the plane of the page as indicated. Light (e.g., from an array of optical phase shifters) propagates within a photonic chip 702 along a first array of waveguides 718A, that includes a first waveguide 704A, and is directly coupled to amplifier waveguides (not shown) in an array of amplifier waveguides (not shown) in an optical amplifier module 708. The light is subsequently directly coupled to a second array of waveguides 718B that includes a second waveguide 704B. Electrodes (not shown) may be located on top of the optical amplifier module 708 (e.g., as shown in FIGS. 7A and 7B), but have been omitted in this view for clarity.

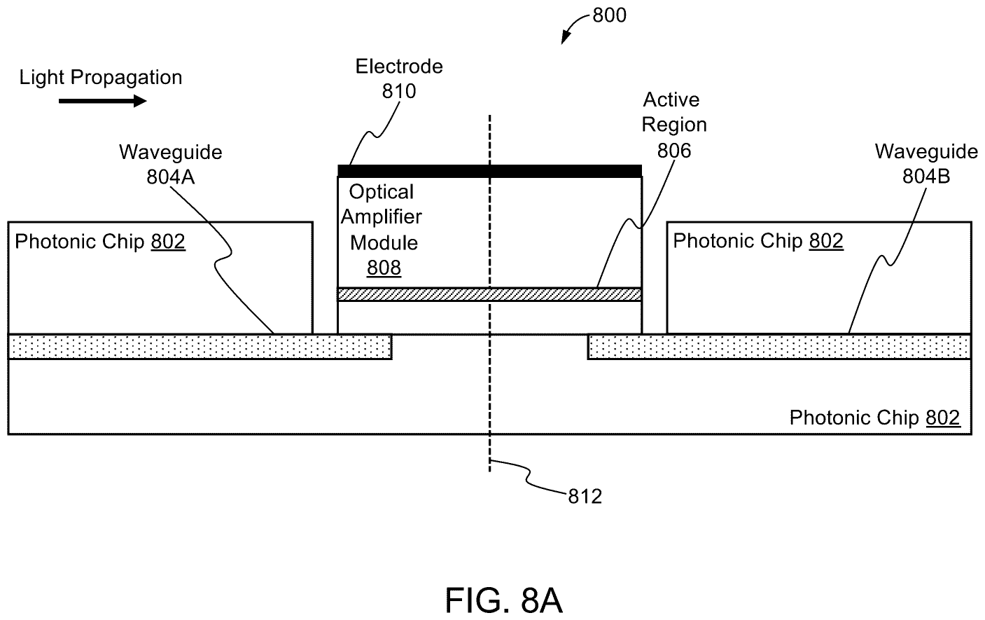

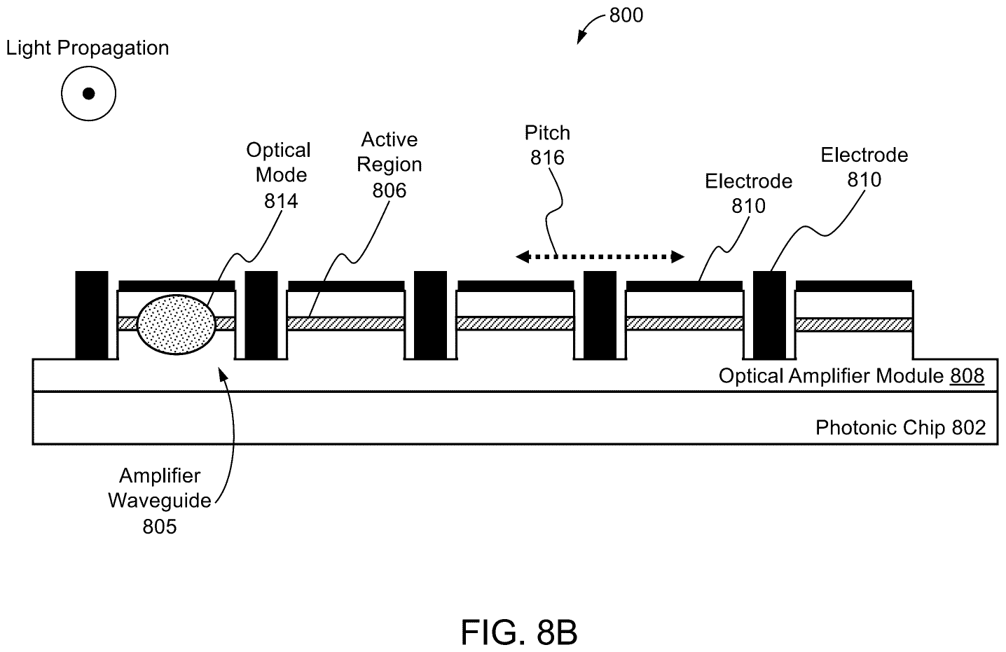

FIG. 8A shows a first cross-sectional view of a portion of an example optically amplified photonic chip assembly 800. Light propagates within a photonic chip 802 along a first waveguide 804A in a first array of waveguides (arrayed into the page, not shown) and is evanescently coupled to an amplifier waveguide (not shown) in an array of amplifier waveguides (arrayed into the page, not shown) containing active regions 806 in an optical amplifier module 808. Electrodes 810 provide electrical pumping of the active regions 806 that amplify the light that is subsequently evanescently coupled to a second waveguide 804B in a second array of waveguides (arrayed into the page, not shown). The optically amplified photonic chip assembly 800 may be assembled by using heterogenous integration techniques, where the optical amplifier module 808, before patterning the array of amplifier waveguides, is bonded to the photonic chip 802 for further processing of the array of amplifier waveguides. By using evanescent coupling between the photonic chip 802 and the array of amplifier waveguides, optical alignment of the two components may be simpler to achieve compared to direct coupling. A dashed line 812 denotes a cross-section (i.e., plane) formed into the page for FIG. 8B.

FIG. 8B shows a second cross-sectional view of a portion of an example optically amplified photonic chip assembly 800, as viewed through a plane denoted by the dashed line 812 of FIG. 8A. An optical mode 814 propagates through the active region 806 and is confined by an amplifier waveguide 805. In general, optical modes can propagate through each of the active regions 806 along respective amplifier waveguides 805. The active regions 806 and the amplifier waveguides 805 are arranged in an array with a pitch 816. In some examples, optical phase shifters (not shown) and optical antennas (not shown) may have also be arranged in an array with the pitch 816 such that no fan-in and fan-out waveguides are used, thereby reducing the total device footprint. Electrodes 810 are located both on top of and laterally displaced from the amplifier waveguides 805. Electrodes 810 located on top of the amplifier waveguides 805 may operate at a different voltage than electrodes 810 laterally displaced from the amplifier waveguides 805 in order to pump the active regions 806.

In general, optical isolation between individual waveguides (e.g., between amplifier waveguides 705 or 805 of FIGS. 7B and 8B, respectively) may be desired in order to reduce waveguide-to-waveguide coupling that can be problematic, especially at a small pitch between waveguides, for creating optical amplifier modules within an OPA.

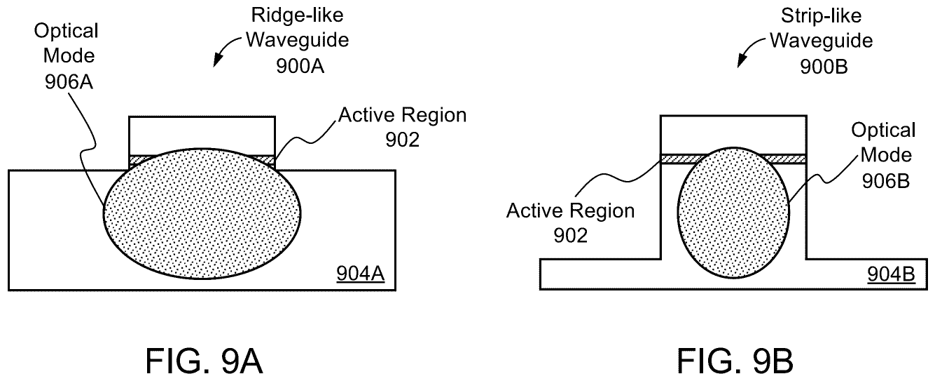

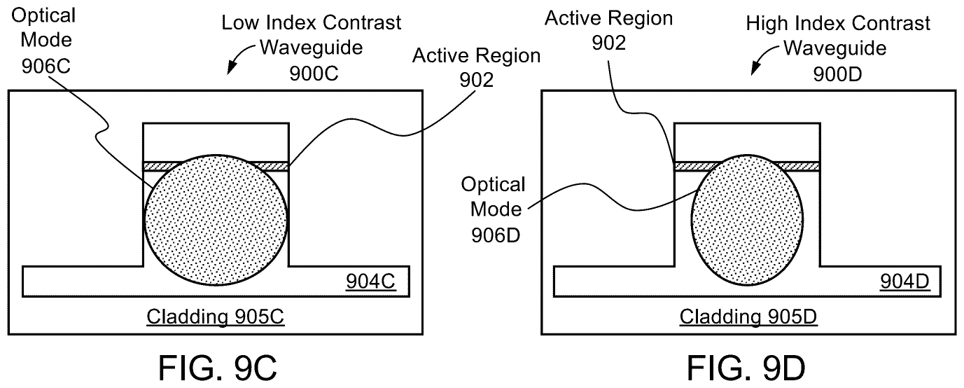

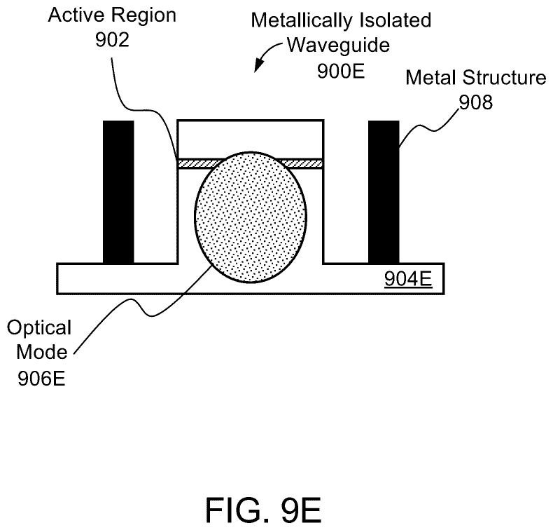

FIGS. 9B, 9D, and 9E show example amplifier waveguides that may reduce waveguide-to-waveguide coupling relative to example amplifier waveguides shown in FIGS. 9A and 9C.

FIG. 9A shows an example ridge-like waveguide 900A comprising an active region 902 formed within a first waveguide core structure 904A (e.g., formed by etching a silicon substrate). The ridge-like waveguide 900A guides a first optical mode 906A that has a first width (e.g., associated with a mode field diameter). In some examples, the first waveguide core structure 904A can be at least partially embedded within a cladding (e.g., air or silicon dioxide (SiO₂)). In general, the index of refraction of the first waveguide core structure 904A will be larger than the index of refraction of the cladding.

FIG. 9B shows an example strip-like waveguide 900B comprising an active region 902 formed within a second waveguide core structure 904B. The strip-like waveguide 900B guides a second optical mode 906B that has a second width smaller than the first width of the first optical mode 906A shown in FIG. 9A. Compared to the ridge-like waveguide 900A of FIG. 9A, the strip-like waveguide 900B has been etched deeper (e.g., substantially deeper than the vertical location of the active region 902) and looks more like a strip-style waveguide rather than a ridge-style waveguide. The strip-like waveguide 900B can increase the confinement of optical modes laterally and reduce their overlap with neighboring waveguides, thereby reducing waveguide-to-waveguide coupling.

FIG. 9C shows an example low index contrast waveguide 900C comprising an active region 902 formed within a third waveguide core structure 904C characterized by a first index of refraction. The low index contrast waveguide 900C guides a third optical mode 906C that has a third width. A first cladding 905C (e.g., silicon dioxide) characterized by a second index of refraction surrounds the third waveguide core structure 904C. A first difference in index of refraction is equal to the magnitude of the difference between the first index of refraction and the second index of refraction.

FIG. 9D shows an example high index contrast waveguide 900D comprising an active region 902 formed within a fourth waveguide core structure 904D characterized by a third index of refraction. The high index contrast waveguide 900D guides a fourth optical mode 906D that has a fourth width smaller than the third width of the third optical mode 906C shown in FIG. 9C. A second cladding 905D (e.g., air or a passivation layer with a low index of refraction) characterized by a fourth index of refraction surrounds the fourth waveguide core structure 904D. A second difference in index of refraction, larger than the first difference in index of refraction, is equal to the magnitude of the difference between the third index of refraction and the fourth index of refraction. The higher index contrast of the high index contrast waveguide 900D can increase the confinement of optical modes and reduce their overlap with neighboring waveguides, thereby reducing waveguide-to-waveguide coupling.

FIG. 9E shows an example metallically isolated waveguide 900E comprising an active region 902 formed within a fifth waveguide core structure 904E. The metallically isolated waveguide 900E guides a fifth optical mode 906E. In some examples, the fifth waveguide core structure 904E can be at least partially embedded within a cladding. Metal structures 908 that can be absorptive and/or reflective to light are located on top of a portion of the fifth waveguide core structure 904E and are laterally displaced from the active region 902 (e.g., in the region between neighboring metallically isolated waveguides 900E). The metal structures 908 can increase optical isolation and thereby reduce waveguide-to-waveguide coupling, and their location and geometry may be chosen so as to reduce excess losses resulting from interactions of the fifth optical mode 906E with the metal structures 908.

In some examples, the optical amplifier module does not contain any amplifier waveguides. In one such example, the light within the OPA remains in waveguides located within the photonic chip and the optical mode of the light evanescently overlaps with and interacts with the active region in the optical amplifier module so as to provide optical gain to the light. Such a configuration can reduce the fabrication and processing complexity since amplifier waveguides are not patterned in the optical amplifier module.

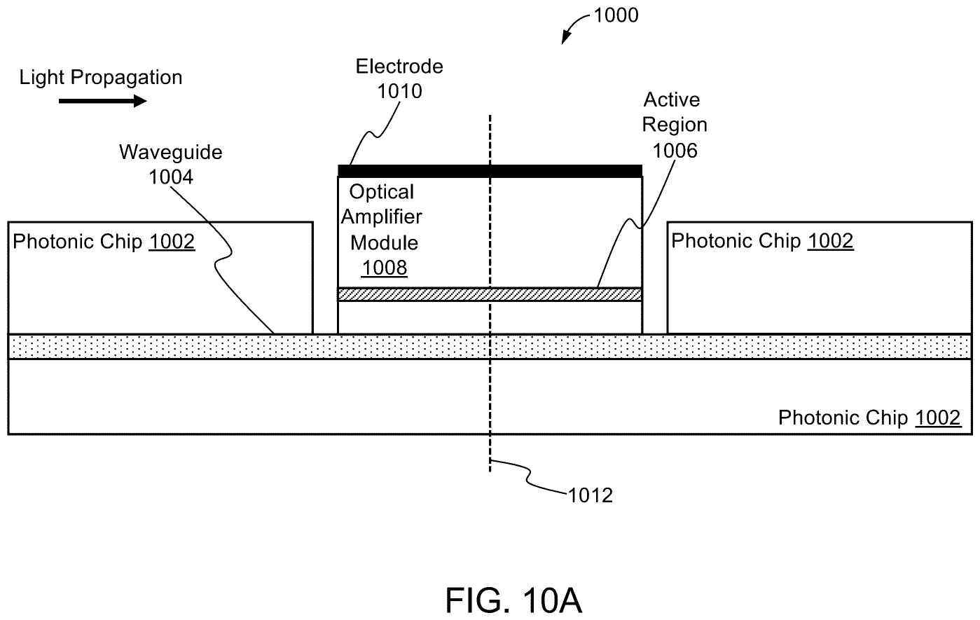

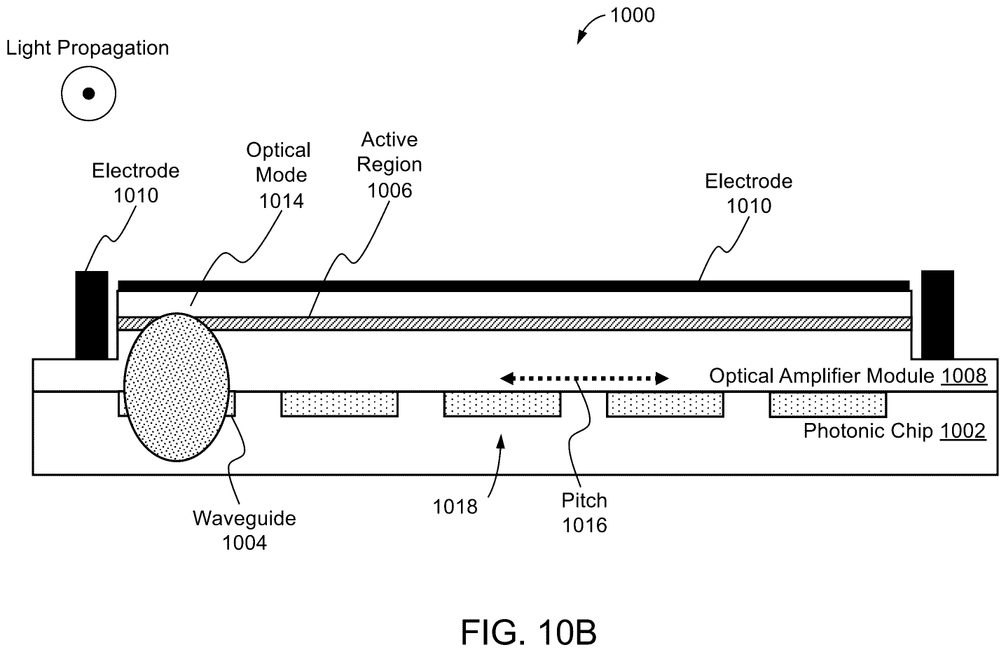

FIG. 10A shows a first cross-sectional view of a portion of an example optically amplified photonic chip assembly 1000. Light propagates within a photonic chip 1002 along a waveguide 1004 in an array of waveguides (arrayed into the page, not shown) and a portion of the propagating mode overlaps with active regions 1006 in an optical amplifier module 1008. Electrodes 1010 provide electrical pumping of the active regions 1006 that amplify the light. The waveguide 1004 may be optically coupled to an array of optical antennas (not shown) that emit the light from the photonic chip 1002. A dashed line 1012 denotes a cross-section (i.e., plane) formed into the page for FIG. 10B.

FIG. 10B shows a second cross-sectional view of a portion of an example optically amplified photonic chip assembly 1000, as viewed through a plane denoted by the dashed line 1012 of FIG. 10A. An optical mode 1014 propagates and overlaps with the active region 1006 in the optical amplifier module 1008 and is confined by the waveguide 1004 in an array of waveguides 1018 located on a photonic chip 1002. In general, optical modes can propagate through each of the active regions 1006 along waveguides in the array of waveguides 1018 characterized by a pitch 1016. Electrodes 1010 are located both on top of the optical amplifier module 1008 and laterally displaced from the active region 1006.

In other examples, the optical amplifier module does not contain amplifier waveguides and the photonic chip does not contain waveguides between the array of optical phase shifters and the optical amplifier module. In such examples, unconfined light from the array of optical phase shifters can be directly coupled or evanescently coupled into the optical amplifier module. If the optically amplified photonic chip assembly is formed by utilizing flip-chip assembly, then direct coupling may be preferable due to electrode placement. If the optically amplified photonic chip assembly is formed by utilizing heterogenous integration, then direct coupling or evanescent coupling may be used with evanescent coupling being preferable in some implementations. In some examples, the optical amplifier module does not contain structures to confine light along the lateral dimension, such that the light received from the array of optical phase shifters diffracts over the length of the optical amplifier module. At the output of the optical amplifier module, the light may be collected by an array of waveguides on the photonic chip or emitted out of the end of the optical amplifier module away from the optically amplified photonic chip assembly.

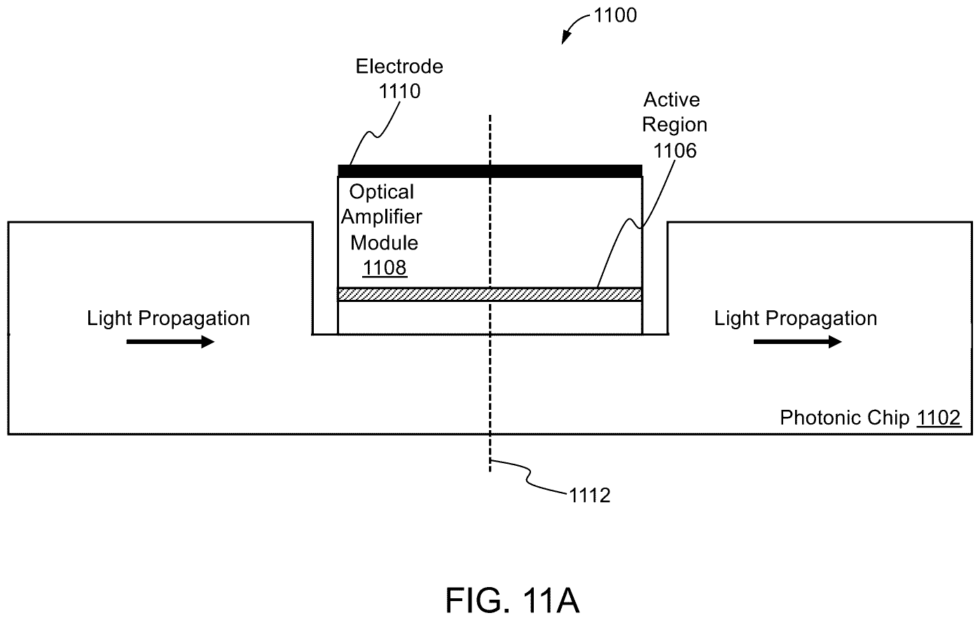

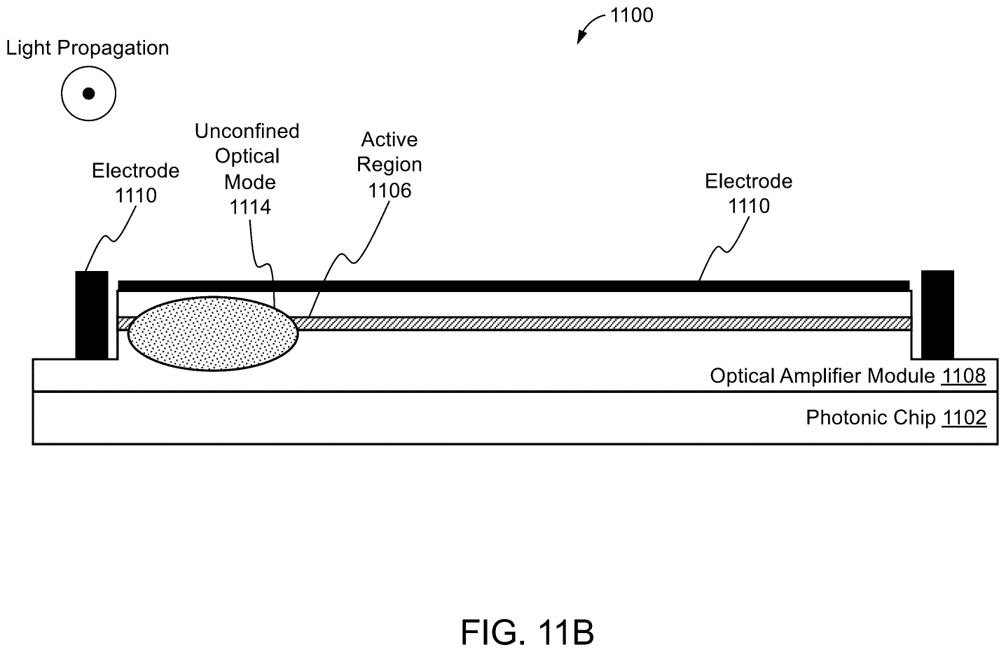

FIG. 11A shows a first cross-sectional view of a portion of an example optically amplified photonic chip assembly 1100 formed using heterogeneous integration. Unconfined light propagates within a photonic chip 1102 and is evanescently coupled to an active region 1106 in an optical amplifier module 1108. Electrodes 1110 provide electrical pumping of the active region 1106 that amplify the light that is subsequently evanescently coupled to the photonic chip 1102. A dashed line 1112 denotes a cross-section (i.e., plane) formed into the page for FIG. 11B.

FIG. 11B shows a second cross-sectional view of a portion of an example optically amplified photonic chip assembly 1100, as viewed through a plane denoted by the dashed line 1112 of FIG. 11A. An unconfined optical mode 1114 propagates through an active region 1106 located in an optical amplifier module 1108 that is located on top of a photonic chip 1102. Electrodes 1110 are located both on top of the optical amplifier module 1108 and laterally displaced from the active region 1106.

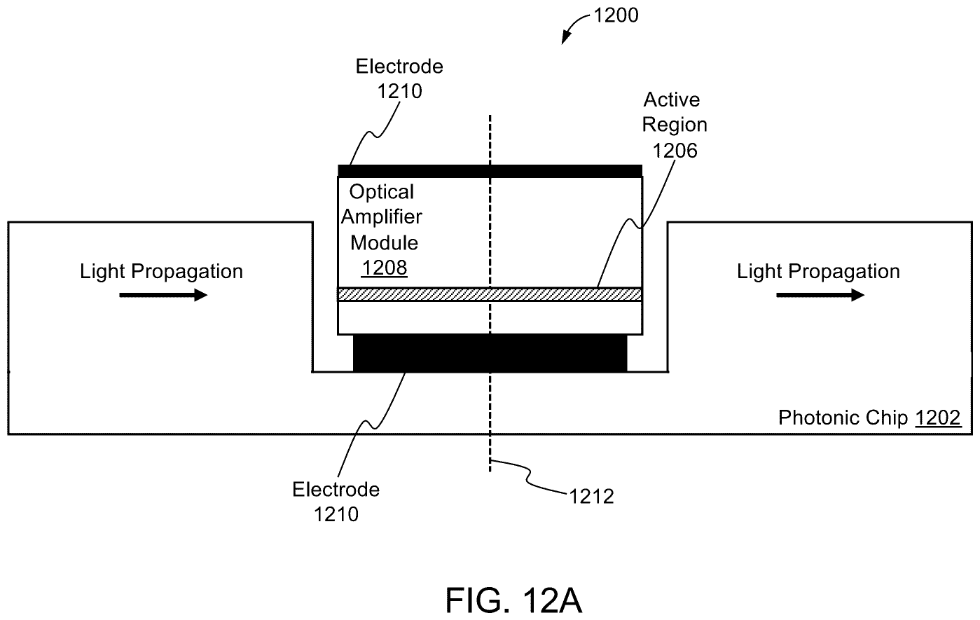

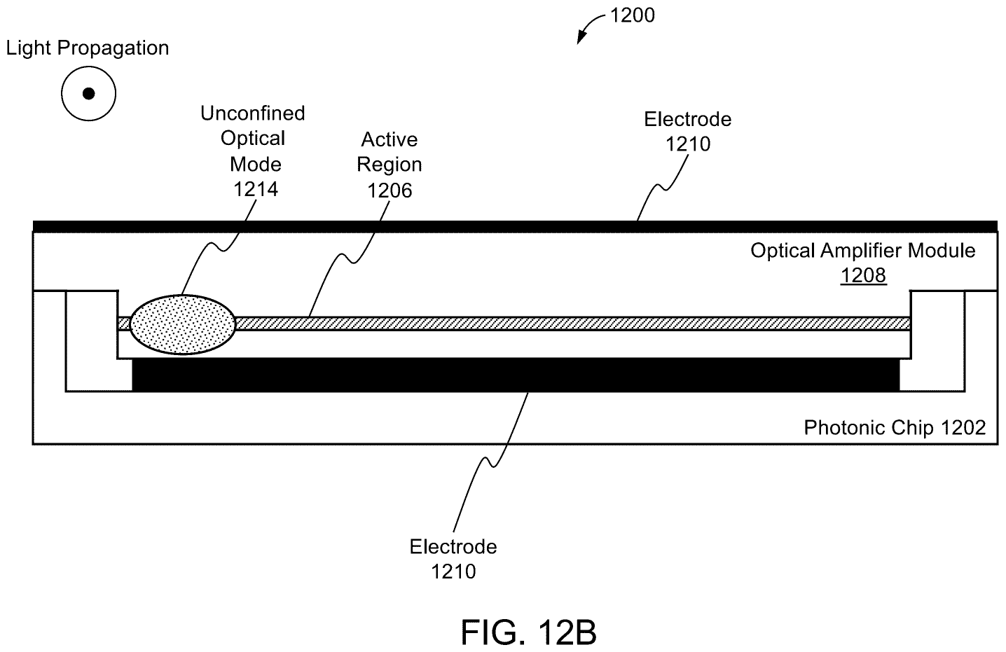

FIG. 12A shows a first cross-sectional view of a portion of an example optically amplified photonic chip assembly 1200 formed using flip-chip assembly. Unconfined light propagates within a photonic chip 1202 and is directly coupled to an active region 1206 in an optical amplifier module 1208. Electrodes 1210 provide electrical pumping of the active region 1206 that amplify the light that is subsequently directly coupled to the photonic chip 1202. A dashed line 1212 denotes a cross-section (i.e., plane) formed into the page for FIG. 12B.

FIG. 12B shows a second cross-sectional view of a portion of an example optically amplified photonic chip assembly 1200, as viewed through a plane denoted by the dashed line 1212 of FIG. 12A. An unconfined optical mode 1214 propagates through an active region 1206 located in an optical amplifier module 1208 that is located on top of a photonic chip 1202. Electrodes 1210 are located both on top of the optical amplifier module 1208 and laterally displaced from the active region 1206.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus comprising:
a photonic chip;
a first array of optical phase shifters in the photonic chip;
a first optical coupler in the photonic chip configured to couple a first optical port to the first array of optical phase shifters; and
an optical amplifier module optically coupled to a first portion of the photonic chip to receive phase shifted optical waves provided from respective optical waveguides in the photonic chip, where the phase shifted optical waves are optically coupled to respective output ports of the first array of optical phase shifters, and where the optical amplifier module is configured to:
provide, after propagation of the phase shifted optical waves through different respective gain regions, amplified optical waves that optically interfere with each other starting at an emission plane to form an optical phased array output beam, and
provide an arrangement of the gain regions such that (1) at least two phase shifted optical waves propagating through adjacent gain regions have optical path lengths between the first optical port and the emission plane that are substantially equal to each other, and (2) a pitch of the gain regions is substantially equal to a pitch of the amplified optical waves at the emission plane.

2. The apparatus of claim 1, further comprising:
a second array of optical phase shifters in the photonic chip;
a second optical coupler in the photonic chip configured to couple a second optical port to the second array of optical phase shifters; and
a receive aperture configured to optically couple a received optical beam, received at the emission plane, to the second array of optical phase shifters.

3. The apparatus of claim 1, wherein the receive aperture is adjacent to a transmit aperture from which the optical phased array output beam is transmitted.

4. The apparatus of claim 1, wherein the pitch of the gain regions is substantially equal to a pitch of the optical phase shifters.

5. The apparatus of claim 1, wherein the emission plane intersects with an edge of the optical amplifier module.

6. The apparatus of claim 1, wherein the optical amplifier module is optically coupled to a second portion of the photonic chip to provide the amplified optical waves to optical antennas in the photonic chip, and the emission plane intersects with an edge or surface of the photonic chip adjacent to the optical antennas.

7. The apparatus of claim 6, wherein the pitch of the gain regions is substantially equal to a pitch of the optical antennas.

8. The apparatus of claim 6, wherein the respective optical waveguides in the first portion of the photonic chip are a first set of optical waveguides, and the second portion of the photonic chip comprises a second set of optical waveguides configured to receive the amplified optical waves from the optical amplifier module.

9. The apparatus of claim 8, wherein the optical amplifier module comprises a substrate different from a material from which the first and second sets of optical waveguides are formed, and the optical amplifier module is positioned at least partially within a trench formed in the photonic chip, where at least one trench surface is adjacent to the first set of optical waveguides and at least one trench surface is adjacent to the second set of optical waveguides.

10. The apparatus of claim 1, wherein the respective optical waveguides all have optical path lengths that are substantially equal to each other.

11. The apparatus of claim 1, wherein the optical amplifier module is configured to provide the arrangement of the gain regions such that all of the phase shifted optical waves propagating through different respective gain regions have optical path lengths between the first optical port and the emission plane that are substantially equal to each other.

12. The apparatus of claim 1, wherein the optical amplifier module is configured to substantially preserve isolation among the phase shifted optical waves as they propagate through the optical amplifier module.

13. The apparatus of claim 12, wherein the respective optical waveguides each define a guided optical mode in a portion of the photonic chip that has a transmittance of at least 80% over an operating wavelength range.

14. The apparatus of claim 13, wherein the optical amplifier module comprises: a substrate that has an optical transmittance of at least 80% over the operating wavelength range, and the respective gain regions in the substrate, where each gain region is positioned to overlap with at least a portion of a respective optical mode in the substrate coupled to a different one of the guided optical modes defined by the respective optical waveguides.

15. The apparatus of claim 14, wherein a first gain region and a second gain region of the plurality of gain regions are isolated from each other by a gap in the substrate.

16. The apparatus of claim 15, wherein the first gain region and the second gain region are isolated from each other by an optically absorptive and/or reflective material within at least a portion of the gap in the substrate.

17. The apparatus of claim 16, wherein the optically absorptive and/or reflective material comprises metal.

18. The apparatus of claim 16, wherein the optically absorptive and/or reflective material is configured as a first electrode that provides current flow between a second electrode and the first electrode during operation, where the current flow crosses at least a portion of the first gain region.

19. A method comprising:
forming a first array of optical phase shifters in a photonic chip;
forming a first optical coupler in the photonic chip configured to couple a first optical port to the first array of optical phase shifters; and
attaching an optical amplifier module to a first portion of the photonic chip to provide optical coupling that receives into the optical amplifier module phase shifted optical waves provided from respective optical waveguides in the photonic chip, where the phase shifted optical waves are optically coupled to respective output ports of the first array of optical phase shifters, and where the optical amplifier module is configured to:
provide, after propagation of the phase shifted optical waves through different respective gain regions, amplified optical waves that optically interfere with each other starting at an emission plane to form an optical phased array output beam, and
provide an arrangement of the gain regions such that (1) at least two phase shifted optical waves propagating through adjacent gain regions have optical path lengths between the first optical port and the emission plane that are substantially equal to each other, and (2) a pitch of the gain regions is substantially equal to a pitch of the amplified optical waves at the emission plane.

20. An apparatus comprising:
a photonic chip;
a first array of optical phase shifters in the photonic chip;
a first optical coupler in the photonic chip configured to couple a first optical port to the first array of optical phase shifters; and
an optical amplifier module optically coupled to a first portion of the photonic chip to overlap with portions of phase shifted optical waves guided by respective optical waveguides in the photonic chip, where the phase shifted optical waves are optically coupled to respective output ports of the first array of optical phase shifters, and where the optical amplifier module is configured to:
provide a gain region that is within a substrate that is adjacent to the respective optical waveguides, and
provide, after propagation of the overlapping portions of the phase shifted optical waves through different respective portions of the gain region, amplified optical waves that optically interfere with each other starting at an emission plane to form an optical phased array output beam.

21. The apparatus of claim 20, further comprising:
a second array of optical phase shifters in the photonic chip;
a second optical coupler in the photonic chip configured to couple a second optical port to the second array of optical phase shifters; and
a receive aperture configured to optically couple a received optical beam, received at the emission plane, to the second array of optical phase shifters.

22. The apparatus of claim 20, wherein the emission plane intersects with an edge of the optical amplifier module.

23. The apparatus of claim 20, wherein the respective optical waveguides provide the amplified optical waves to optical antennas in the photonic chip, and the emission plane intersects with an edge or surface of the photonic chip adjacent to the optical antennas.

24. The apparatus of claim 23, wherein the optical amplifier module comprises substrate different from a material from which the respective optical waveguides are formed, and the optical amplifier module is positioned at least partially within a trench formed in the photonic chip, where at least one trench surface is adjacent to the respective optical waveguides.

25. A method comprising:
forming a first array of optical phase shifters in a photonic chip;
forming a first optical coupler in the photonic chip configured to couple a first optical port to the first array of optical phase shifters; and
attaching an optical amplifier module to a first portion of the photonic chip to provide optical coupling that overlaps the optical amplifier module with portions of phase shifted optical waves guided by respective optical waveguides in the photonic chip, where the phase shifted optical waves are optically coupled to respective output ports of the first array of optical phase shifters, and where the optical amplifier module is configured to:
provide a gain region that is within a substrate that is adjacent to the respective optical waveguides, and
provide, after propagation of the overlapping portions of the phase shifted optical waves through different respective portions of the gain region, amplified optical waves that optically interfere with each other starting at an emission plane to form an optical phased array output beam.
